(19) United States
(12) Patent Application Publication
(10) Pub. No.: US 2013/0230168 A1
(43) Pub. Date: Sep. 5, 2013

(54) INFORMATION PROCESSING DEVICE, INFORMATION PROCESSING METHOD, AND COMPUTER READABLE MEDIUM

(71) Applicant: Takao Takenouchi, Tokyo (JP)

(72) Inventor: Takao Takenouchi, Tokyo (JP)

(73) Assignee: NEC CORPORATION, Tokyo (JP)

(21) Appl. No.: 13/883,676

(22) PCT Filed: Nov. 14, 2011
(86) PCT No.: PCT/JP2011/076611

§ 371 Date: May 6, 2013

(30) Foreign Application Priority Data
Nov. 15, 2010 (JP) 2010-254971

(51) Int. Cl. H04L 9/08

(52) U.S. Cl. CPC H04L 9/0816
USPC 380/46

(57) ABSTRACT

To anonymize information from a service-providing apparatus and an information processing apparatus (device), this information processing apparatus is provided with: the an information receiver for receiving anonymized (concealed) information that has been anonymized with anonymizing information; the an anonymized random-number generator for generating random numbers or anonymized random numbers obtained by anonymizing the random numbers with anonymizing information; and a random-number-added information generator for generating random-number-added information on the basis of the anonymized information and the random numbers or anonymized random numbers.

### FIELD OF THE INVENTION

The present invention relates to a device for transmitting and receiving information and particularly relates to an information processing device for securely transmitting and receiving information.

### BACKGROUND OF THE INVENTION

A vendor (service provider) which provides service through a network such as the internet connects an apparatus for providing service (service providing apparatus) to the network. A user of such service providing apparatus transmits information about self (attribute information) to the service providing apparatus in order to get the service. The service providing apparatus holds the received user's attribute information in a predetermined apparatus (information or attribute providing apparatus). Then, when providing the service, the service providing apparatus extracts the user's attribute information from the information or attribute providing apparatus, and provides the service based on the extracted attribute information. However, the service provided by the service providing apparatus is different for each service providing apparatus. Consequently, the attribute information which the service providing apparatus receives from the user is different for each service providing apparatus. As a result, the user's attribute information held by the information or attribute providing apparatus is different for each information or attribute providing apparatus even when the user's attribute information held by the information or attribute providing apparatuses are the attribute information of the same user.

The service providing apparatus can provide a new service to the user by using combination of the attribute information which such different information or attribute providing apparatuses holds.

For example, such service will be described by referring to a service provision system 9 shown in FIG. 12. A service providing apparatus 90 provides a service with respect to a user's property and holds information about the property in an information or attribute providing apparatus 91. A service providing apparatus 92 provides a service with respect to a user's debt and holds information about the user's debt in an information or attribute providing apparatus 93. Here, a service providing apparatus 94 can acquire the information about the property held by the information or attribute providing apparatus 91 and the information about the debt held by the information or attribute providing apparatus 93, compare them, and provide user's credit information (property—debt).

However, user's attribute information is important information, and communication with secured safety is necessary for it.

Therefore, the apparatus which uses the information does not transmit all the user information, but it performs a process by using a part of the information to secure the safety (for example, refer to patent document 1).

However, the apparatus described in patent document 1 transmits a part of the user's attribute information.

Therefore, the apparatus which uses the information can secure the safety by using other information related to original information (for example, refer to patent document 2). However, because the apparatus described in patent document 2 uses other information having a special relationship with the original information, it is necessary to arrange the other information between apparatuses which transmits and receives information in advance. Accordingly, the apparatus described in patent document 2 cannot transmit and receive the general information.

Therefore, the apparatus which transmits and receives information uses encryption of information for transmitting and receiving the information (for example, refer to patent document 3). However, the data totaling apparatus described in patent document 3 needs to decrypt the information and perform a totaling process. Accordingly, the information processing apparatus described in patent document 3 can know the received information.

However, for the vendor which provides service (information holding vendor), the held user's attribute information is the asset. Therefore, when the information holding vendor (vendor of the information or attribute providing apparatus 91 or the information or attribute providing apparatus 93 shown in FIG. 12) is different from a vendor which receives information and provides service (information using vendor, a vendor of the service providing apparatus 94 shown in FIG. 12), the information holding vendor wants to conceal the attribute information from the information using vendor.

The homomorphic encryption is used to satisfy such request. The homomorphic encryption is an encryption which allows the operation of information in an encrypted form, in other words without performing decryption. The information processing apparatus can process the information in an encrypted form by using the homomorphic encryption (for example, refer to patent document 4).

The apparatus described in patent document 4 operates as follows. A user encrypts self information desired to be compared with a user's public key and transmits it to an apparatus for comparing the information. The apparatus for comparing the information encrypts by using the user's public key, the information which the apparatus holds and is used for comparison, and compares it with the received information which is encrypted by the user. The apparatus for comparing the information transmits the encrypted information which is corresponding to the user. The user decrypts the received information with a user's secret key.

Further, an RSA (Rivest Shamir and Adleman) encryption, an ElGamal encryption, a Paillier encryption, or the like is used as the homomorphic encryption.
[Patent document 1] Republication W2005/022428
[Patent document 2] Japanese Patent Application Laid-Open No. 2006-236093
[Patent document 3] Japanese Patent Application Laid-Open No. 2010-166228
[Patent document 4] Japanese Patent Application Laid-Open No. 2009-093618

### SUMMARY OF THE INVENTION

### Problems to be Solved by the Invention

The above-mentioned apparatus for performing a judgment described in patent document 4 is an invention which receives the encryption key and the encrypted information from a provider (in patent document 4, the user's apparatus) who provides information to be compared, encrypts the information held by itself, and judges whether the information is corresponding to the received information. In other words, the apparatus described in patent document 4 receives the encrypted information to be compared and the public key from another apparatus and processes it with the information held by itself.

However, the public key is different for each apparatus. And, the information which can be processed in encrypted with homomorphic encryption is the information which is encrypted with the same encryption key.

Therefore, the apparatus described in patent document 4 cannot process the information received from a plurality of apparatuses. For example, even when the service providing apparatus 94 shown in FIG. 12 receives the encrypted information and the public key from the information or attribute providing apparatus 91 and the information or attribute providing apparatus 93, the service providing apparatus 94 cannot process the information in an encrypted form because the public key of the information or attribute providing apparatus 91 is different from that of the information or attribute providing apparatus 93. In other words, the apparatus described in patent document 4 has a problem in which the apparatus cannot process the encrypted information received from a plurality of apparatuses.

Further, when the apparatus which performs a process (the service providing apparatus 94 shown in FIG. 12) provides the self public key to the information or attribute providing apparatus 91 and the information or attribute providing apparatus 93 and receives the encrypted information, the service providing apparatus 94 can process the encrypted information. However, because this public key is for the service providing apparatus 94, there is a problem in which the service providing apparatus 94 (information use vendor) can decrypt the received information and the attribute information cannot be concealed from the service providing apparatus 94.

An object of the present invention is to provide an information processing device which solves the above-mentioned problem, acquires the user's attribute information from a plurality of information or attribute providing apparatuses in a concealed state, and transmits information of which a judgment process can be performed while concealing the attribute information in an apparatus (service providing apparatus) for performing a judgment.

### Means for Solving the Problem

An information processing device of the present invention includes: an information reception means for receiving concealed information which is concealed with information for concealment; a concealed random number generation means for generating a random number or a concealed random number which is concealed the random number with the information for concealment; and a random number addition information generation means for generating random number addition information based on the concealed information and the random number or the concealed random number.

An information processing method of the present invention includes: receiving concealed information which is concealed with information for concealment; generating a random number or a concealed random number which is concealed the random number with the information for concealment; and generating random number addition information based on the concealed information and the random number or the concealed random number.

A program of the present invention causes a computer to execute: a process of receiving concealed information which is concealed with information for concealment; a process of generating a random number or a concealed random number which is concealed the random number with the information for concealment; and a process of generating random number addition information based on the concealed information and the random number or the concealed random number.

An information processing system of the present invention includes: a service providing apparatus for providing service to a user; an information or attribute providing apparatus for holding information for service provision by the service providing apparatus; and an information processing device for receiving concealed information, which is first information, concealed based on information for concealment of the service providing apparatus from the information or attribute providing apparatus, generating a random number or a concealed random number which is concealed the random number with the information for concealment, generating random number addition information, which is second information, based on the concealed information and the random number or the concealed random number, and transmitting the random number addition information to the service providing apparatus.

### Effect of the Invention

According to the present invention, it is possible to achieve the effect in which information can be acquired from the information or attribute providing apparatus while concealing the information and the information is provided so that the information can be processed in the service providing apparatus while concealing the information.

### BRIEF DESCRIPTION OF THE DRAWINGS

FIG. 1 is a block diagram showing an example of a service provision system according to a first exemplary embodiment of the present invention.

FIG. 2 is a block diagram showing an example of an information or attribute acquisition proxy apparatus according to the first exemplary embodiment.

FIG. 3 is a sequence diagram showing an example of operation of a system including an information or attribute acquisition proxy apparatus according to the first exemplary embodiment.

FIG. 4 is a figure showing an example of data of information request according to the first exemplary embodiment.

FIG. 5 is a block diagram showing another example of an information or attribute acquisition proxy apparatus according to the first exemplary embodiment.

FIG. 6 is a block diagram showing another example of a service provision system according to the first exemplary embodiment.

FIG. 7 is a block diagram showing an example of an information or attribute acquisition proxy apparatus according to a second exemplary embodiment.

FIG. 8 is a flowchart showing an example of operation of a random number addition information generation unit according to the second exemplary embodiment.

FIG. 9 is a flowchart showing an example of operation of a random number addition information generation unit according to a third exemplary embodiment.

FIG. 10 is a flowchart showing an example of operation of a random number addition information generation unit according to a fourth exemplary embodiment.

FIG. 11 is a block diagram showing an example of a configuration of an information or attribute acquisition proxy apparatus according to a fifth exemplary embodiment.

FIG. 12 is a figure showing a general service provision system.

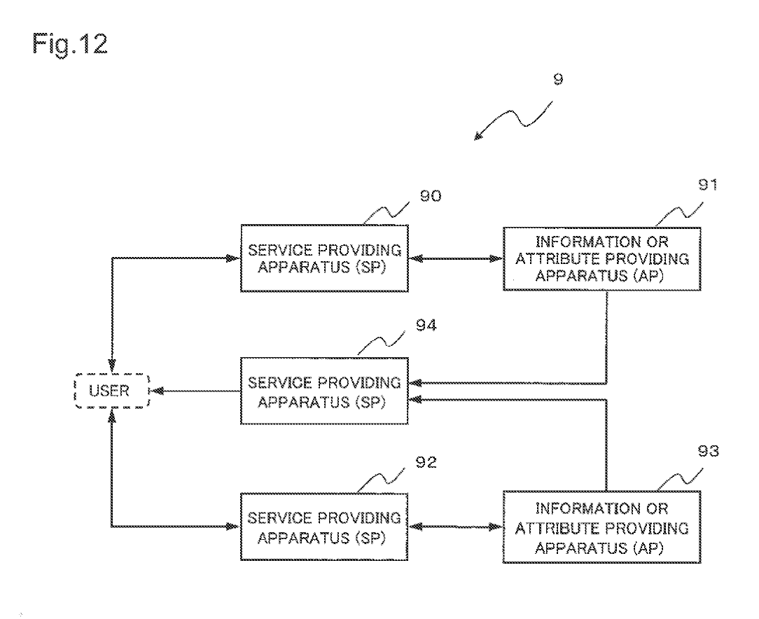

### EXEMPLARY EMBODIMENT OF THE INVENTION

Next, an exemplary embodiment of the present invention will be described with reference to the drawing.

The information processing device of the present invention can be realized as devices according to various exemplary embodiments. However, in the following description, explanation will be performed by using an information or attribute acquisition proxy apparatus (hereinafter, the information or attribute acquisition proxy apparatus may be referred to as AAP) as an example.

### First Exemplary Embodiment

An information or attribute acquisition proxy apparatus 10 according to a first exemplary embodiment of the present invention will be described with reference to the drawing.

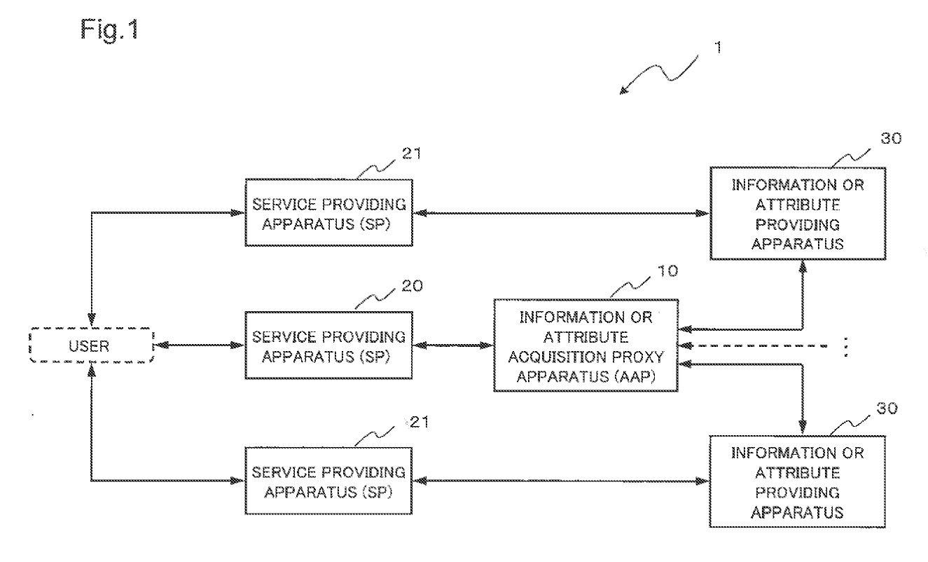

FIG. 1 is a block diagram showing an example of a service provision system 1 including the information or attribute acquisition proxy apparatus 10.

The service provision system 1 includes the information or attribute acquisition proxy apparatus 10, a service providing apparatus 20 (hereinafter, the service providing apparatus may be referred to as SP), a service providing apparatus 21, and an information or attribute providing apparatus 30 (hereinafter, the information or attribute providing apparatus may be referred to as AP). Further, each apparatus is connected to each other via a network. And, the information or attribute acquisition proxy apparatus 10 may be connected to one or more service providing apparatuses 20 and one or more information or attribute providing apparatuses 30. For convenience of explanation, FIG. 1 shows one service providing apparatus 20 and two information or attribute providing apparatuses 30.

The information or attribute acquisition proxy apparatus 10 receives an information request from the service providing apparatus 20. The information request is a request for acquiring information from the information or attribute providing apparatus 30 for providing service to a user through the service providing apparatus 20. Further, the information or attribute acquisition proxy apparatus 10 generates a request (hereinafter, this request is referred to as an individual apparatus request) for requesting information to the information or attribute providing apparatus 30 on each based on the information request, and transmits it to the information or attribute providing apparatus 30. And, the information or attribute acquisition proxy apparatus 10 receives first information (hereinafter, this first information is referred to as concealed information) which is concealed from the information or attribute providing apparatus 30, generates second information (For example, it is the information to which a random number is added. And Hereinafter, this second information is referred to as random number addition information.) which is concealed, and transmits it to the service providing apparatus 20.

The service providing apparatus 20 transmits the information request to the information or attribute acquisition proxy apparatus 10, and receives the concealed second information (the random number addition information) from the information or attribute acquisition proxy apparatus 10. The service providing apparatus 20 provides a service to the user by using the concealed second information (random number addition information) which is received.

The service providing apparatus 21 receives information about the user who uses a service from a user's terminal in advance (hereinafter, the information about the user is referred to as attribute information) and holds it in the information or attribute providing apparatus 30 in order to provide a predetermined service to the user. The service providing apparatus 21 provides the predetermined service to the user by using the information (attribute information) held in the information or attribute providing apparatus 30. As described above, the information or attribute acquisition proxy apparatus 10 acquires the information, which is held in the information or attribute providing apparatus 30 by the service providing apparatus 21, based on the information request. Further, the service providing apparatus 20 may be the service providing apparatus 21.

The information or attribute providing apparatus 30 receives the attribute information from the service providing apparatus 21 and holds it. And, the information or attribute providing apparatus 30 receives the individual apparatus request from the information or attribute acquisition proxy apparatus 10 and transmits the concealed first information (concealed information) to the information or attribute acquisition proxy apparatus 10.

Because a computer such as a general server including a processing apparatus such as a CPU (Central Process Unit) and a storage device can be used as the service providing apparatus 20, the service providing apparatus 21, and the information or attribute providing apparatus 30, the detailed description of the configuration will be omitted.

Next, the configuration of the information or attribute acquisition proxy apparatus 10 according to this exemplary embodiment will be described.

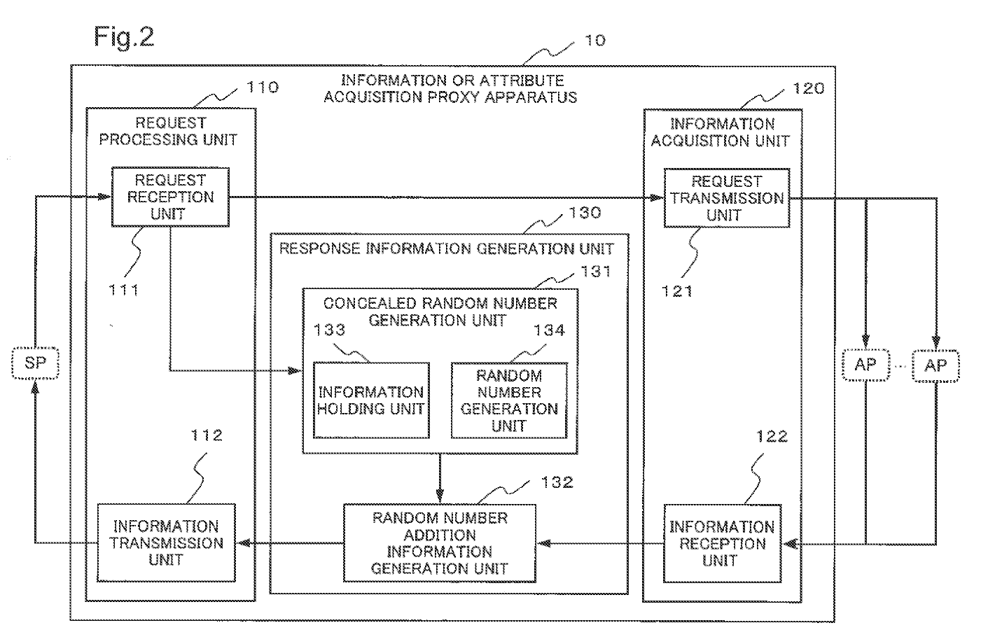

FIG. 2 is a block diagram showing an example of the configuration of the information or attribute acquisition proxy apparatus 10.

The information or attribute acquisition proxy apparatus 10 includes a request processing unit 110, an information acquisition unit 120, and a response information generation unit 130.

The request processing unit 110 receives the information request from the service providing apparatus 20 and transmits the random number addition information to the service providing apparatus 20 as a response to it. For that purpose, the request processing unit 110 includes a request reception unit 111 and an information transmission unit 112.

The request reception unit 111 receives the information request from the service providing apparatus 20. The request reception unit 111 which receives the information request transmits the information request to the information acquisition unit 120. Further, the request reception unit 111 extracts information (for example, information for concealment mentioned later) which is included in the information request and used by the response information generation unit 130 and transmits it to the response information generation unit 130.

The information transmission unit 112 receives the information (random number addition information) which is returned to the service providing apparatus 20 from the response information generation unit 130 and transmits it back to the service providing apparatus 20.

The information acquisition unit 120 transmits the individual apparatus request to the information or attribute providing apparatus 30, and receives the concealed first information (concealed information) from the information or attribute providing apparatus 30 as a response to it. For that purpose, the information acquisition unit 120 includes a request transmission unit 121 and an information reception unit 122.

The request transmission unit 121 receives the information request from the request processing unit 110, generates the individual apparatus request for requesting the information to the individual information or attribute providing apparatus 30 based on the received information request, and transmits it to the individual information or attribute providing apparatus 30.

The information reception unit 122 receives the concealed first information (concealed information) corresponding to the information requested by using the individual apparatus request from the information or attribute providing apparatus 30, and transmits it to the response information generation unit 130.

The concealed information generation unit 130 generates the random number addition information as the concealed second information based on the concealed information. For that purpose, the response information generation unit 130 includes a concealed random number generation unit 131 and a random number addition information generation unit 132.

The concealed random number generation unit 131 receives information (Hereinafter, it is referred to as information for concealment. For example, the information for concealment is a public key of the service providing apparatus 20 for encryption.), which is used for concealing the information from the information or attribute acquisition proxy apparatus 10 and is included in the information request, from the request processing unit 110, and holds it in an information holding unit 133. Further, the concealed random number generation unit 131 generates the concealed random number which is concealed (encrypted) the random number generated by a random number generation unit 134 with the information for concealment (public key) held by the information holding unit 133, and transmits it to the random number addition information generation unit 132. Here, the “random number” generated by the random number generation unit 134 is a natural number that occurs without regularity. However, this random number may be a pseudo random number which cannot be predicted regularity by the service providing apparatus 20 and cannot be distinguished from a random number sequence. Further, when the random number generation unit 134 generates the pseudo random number, if the random number generation unit 134 generates the pseudo random number which cannot be predicted regularity by the service providing apparatus 20, the random number generation unit 134 may generate the pseudo random number which has regularity and may set a range of the generated pseudo random number. For example, the random number generation unit 134 may generate a (pseudo) uniform random number whose occurrence frequency is uniform in a predetermined value range. Alternatively, the random number generation unit 134 may generate the pseudo random number whose occurrence frequency conforms to a predetermined distribution, such as for example a normal distribution, in the predetermined value range.

Further, though the concealed random number generation unit 131 shown in FIG. 2 includes the information holding unit 133 and the random number generation unit 134, it is not limited to this. The information or attribute acquisition proxy apparatus 10 may have a configuration in which either the information holding unit 133 or the random number generation 134 or both of them are arranged outside the concealed random number generation unit 131.

The random number addition information generation unit 132 performs a predetermined operation by using the concealed first information (concealed information) received from the information or attribute providing apparatus 30 through the information reception unit 122 and the information (concealed random number) received from the concealed random number generation unit 131, and transmits a result to the request processing unit 110 as the random number addition information which is the concealed second information.

Next, the operation of the information or attribute acquisition proxy apparatus 10 according to this exemplary embodiment will be described with reference to the drawing.

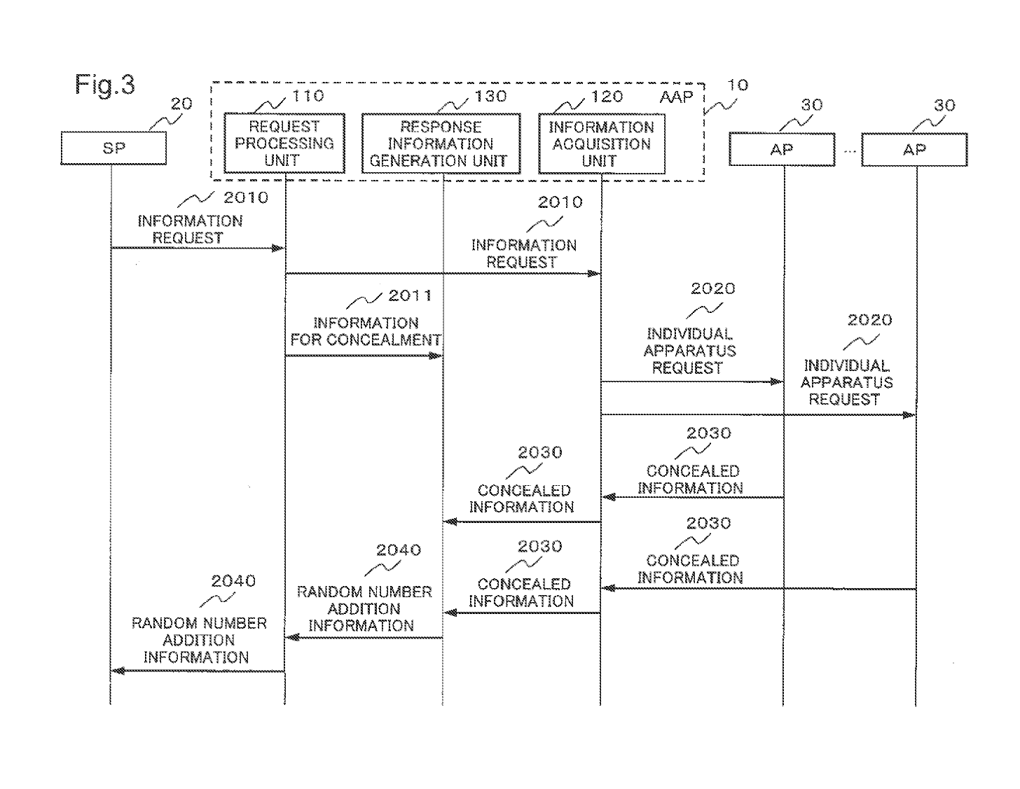

FIG. 3 is a sequence diagram showing an example of the operation of the service provision system 1 including the information or attribute acquisition proxy apparatus 10 according to this exemplary embodiment.

The service providing apparatus 21 holds the information in the information or attribute providing apparatus 30, in advance. Further, because the operation of this service providing apparatus 21 is a general information holding operation, the detailed explanation is omitted and its operation is also omitted in FIG. 3.

The service providing apparatus (SP) 20 transmits an information request 2010 to the request processing unit 110 of the information or attribute acquisition proxy apparatus (AAP) 10.

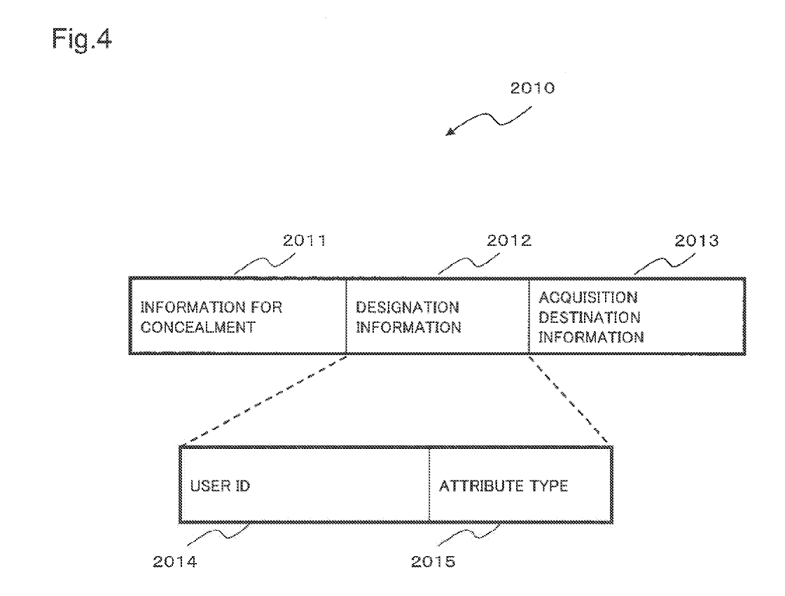

FIG. 4 is a figure showing an example of a structure of data of the information request 2010 according to this exemplary embodiment.

The information request 2010 includes information (information for concealment 2011) for concealing the information held by the information or attribute providing apparatus 30 from the information or attribute acquisition proxy apparatus 10, information (hereinafter, referred to as designation information 2012) about the information to be acquired, and information (hereinafter, referred to as acquisition destination information 2013) about an acquisition destination of the information.

The information for concealment 2011 according to this exemplary embodiment is the information for concealment 2011 which the information or attribute acquisition proxy apparatus 10 can process while the information is concealed. Here, to be able to process while concealed means that the information or attribute acquisition proxy apparatus 10 can perform an operation of the concealed first information (concealed information 2030), which is concealed based on the information for concealment 2011 and received from the information or attribute providing apparatus 30, without decrypting, in other words while keeping concealed form.

For example, the homomorphic encryption can be performed an operation of encrypted (concealed) data in an encrypted (concealed) form. Thus, the information for concealment 2011 according to this exemplary embodiment is not limited when the process can be performed while concealing. Hereinafter, as an example, the information for concealment 2011 according to this exemplary embodiment is a public key of homomorphic encryption of the service providing apparatus 20.

The designation information 2012 is information indicating information to be acquired. For example, the designation information 2012 includes information (a user ID 2014 (ID: Identification, identifier)) for identifying a user who provides the information requested by the service providing apparatus 20 to the information or attribute providing apparatus 30 and a designation (an attribute type 2015) of the information to be acquired.

The acquisition destination information 2013 includes information (for example, URI (Uniform Resource Identifier) or an apparatus name) indicating the information or attribute providing apparatus 30 corresponding to the acquisition destination of the information.

Further, when the acquisition destination information 2013 includes a plurality of acquisition destinations, the information request 2010 includes information for combining each designation information 2012 and the acquisition destination information 2013 from which the designation information 2012 is acquired.

And, the information request 2010 may include other information, for example, a header for communication or the like.

The explanation will be performed by using FIG. 3 again.

The request processing unit 110 transmits the received information request 2010 to the information acquisition unit 120.

Further, the request processing unit 110 extracts the information for concealment 2011 (public key) included in the information request 2010, and transmits it to the response information generation unit 130. The response information generation unit 130 holds the received information for concealment 2011 (public key).

The information acquisition unit 120 which receives the information request 2010 determines the information or attribute providing apparatus 30 to which the information is requested based on the acquisition destination information 2013 of the information request 2010. Further, the information acquisition unit 120 generates a request (an individual apparatus request 2020) for the information to the individual information or attribute providing apparatus 30 based on the information request 2010, and transmits it to the each information or attribute providing apparatus 30. Here, the reason why the information acquisition unit 120 generates the individual apparatus request 2020 is that the information held by the other information possession apparatus 30 is not known to the each information or attribute providing apparatus 30.

This individual apparatus request 2020 includes the information for concealment 2011 included in the information request 2010 and the designation information 2012 (the user ID 2014 and the attribute type 2015).

Further, in the explanation of this exemplary embodiment, it is supposed that the information for concealment 2011 (the public key of the service providing apparatus 20) is the information which is included in the information request 2010 and transmitted to the information or attribute acquisition proxy apparatus 10 by the service providing apparatus 20. However, there is a case in which the public key may be managed by a public key management server which is shown and connected to the network. And, it is supposed that there is a case in which the information or attribute acquisition proxy apparatus 10 receives the information request 2010 from the illegal service providing apparatus 20. Therefore, the information or attribute acquisition proxy apparatus 10 may acquire the information for concealment 2011 (public key) of the service providing apparatus 20 from the public key management server whose reliability is ensured. When the information or attribute acquisition proxy apparatus 10 acquires the information for concealment 2011 from the public key management server, the response information generation unit 130 of the information or attribute acquisition proxy apparatus 10 should hold the acquired information for concealment 2011 and the information acquisition unit 120 should include the acquired information for concealment 2011 in the individual apparatus request 2020. Further, when the information or attribute acquisition proxy apparatus 10 receives the information for concealment 2011 from the public key management server, the information request 2010 may not include the information for concealment 2011.

The information or attribute providing apparatus 30 generates the first information (concealed information 2030) which is concealed (encrypted) the information (for example, attribute information (a deposit, a debt, or the like) of a predetermined user) requested by the designation information 2012 included in the individual apparatus request 2020 by using the information for concealment 2011 (the public key of the service providing apparatus 20) included in the received individual apparatus request 2020. Base on this operation, the concealed first information (the concealed information 2030) transmitted by the information or attribute providing apparatus 30 is concealed from the information or attribute acquisition proxy apparatus 10. The information or attribute providing apparatus 30 transmits the first concealed information (the concealed information 2030) to the information acquisition unit 120 of the information or attribute acquisition proxy apparatus 10.

Further, the information or attribute providing apparatus 30 may acquire the information for concealment 2011 from the public key management server which is not shown without using the information for concealment 2011 included in the individual apparatus request 2020. However, in this case, the information or attribute providing apparatus 30 receives the information about the service providing apparatus 20 that requests the information from the information or attribute acquisition proxy apparatus 10, because it receives the information for concealment 2011 from the public key management server. And, in this case, the individual apparatus request 2020 may not include the information for concealment 2011.

The information acquisition unit 120 which receives the concealed information 2030 transmits the received concealed information 2030 to the response information generation unit 130.

The response information generation unit 130 generates the random number and generates the concealed random number which is concealed (encrypted) the generated random number with the information for concealment 2011(public key) which is held in it. Here, as described above with reference to FIG. 2, the concealed random number is a number which is generated by concealing (encrypting) the random number generated by the random number generation unit 134 of the concealed random number generation unit 131 with the information for concealment 2011 (public key) held in the information holding unit 133.

The response information generation unit 130 which receives all the concealed information 2030 corresponding to the information request 2010 performs the predetermined operation by using the generated concealed random number and the concealed information 2030, generates an operation result as second information (random number addition information 2040), and outputs it. The information on the information or attribute providing apparatus 30 which is a base of the random number addition information 2040 is concealed from the service providing apparatus 20 based on the operation performed by the response information generation unit 130 by using the concealed random number and the concealed information 2030. Further, this operation will be described again later.

The response information generation unit 130 transmits the random number addition information 2040, which is the generated concealed second information, to the request processing unit 110.

The request processing unit 110 transmits the received random number addition information 2040 to the service providing apparatus 20.

The service providing apparatus 20, which receives the random number addition information 2040 which is the concealed second information, decrypts the random number addition information 2040 with the self secret key, and provides a service to the user who is not shown based on the decrypted information.

Next, it will be describe that the information held by the information or attribute providing apparatus 30 is concealed from the information or attribute acquisition proxy apparatus 10 and the service providing apparatus 20, and the service providing apparatus 20 can provide a predetermined service while concealing the information.

Here, the premise of the explanation is put in order.

First, it is supposed that the service providing apparatus 20 calculates a difference (credit information) between an account balance and a paid amount, that is, an amount of debt of user. It is supposed that the account balance (hereinafter, referred to as A) and the amount of debt (hereinafter, referred to as B) are held in the different information or attribute providing apparatuses 30, respectively. Further, it is supposed that the random number is represented by R.

And, it is supposed that the information for concealment 2011 (encryption key) is the public key of the service providing apparatus 20. It is supposed that this function indicating the concealment (encryption) is represented as follows.

Enc(x) (However, x is information to be encrypted.)

Further, the information for concealment 2011 according to this exemplary embodiment may be performed an operation while concealed as described above.

However, for convenience of explanation, in the following explanation, it is supposed that the information for concealment 2011 is a public key of an additive homomorphic encryption. Further, the additive homomorphic encryption can be supposed a variety. In the description described below, it is supposed that the additive homomorphic encryption satisfies the following equation.

Additive homomorphic encryption:Enc(x)*Enc(y)=Enc(x+y)

The operation under the above-mentioned conditions will be described.

The each information or attribute providing apparatus 30 encrypts (conceals) the account balance (A) or the amount of debt (B) with the public key of the service providing apparatus 20 and transmits it to the information or attribute acquisition proxy apparatus 10 in response to the individual apparatus request 2020.

In other words, the information or attribute acquisition proxy apparatus 10 receives Enc(A) and Enc(B). Here, because Enc(A) and Enc(B) are encrypted with the public key of the service providing apparatus 20, the information or attribute acquisition proxy apparatus 10 cannot decrypt them. Therefore, the information or attribute acquisition proxy apparatus 10 cannot know the account balance (A) and the amount of debt (B).

Next, the information or attribute acquisition proxy apparatus 10 generates the concealed random number which is concealed (encrypted) the random number (R) with the information for concealment 2011 (the public key) of the service providing apparatus 20. The concealed random number becomes Enc(R). Further, the information for concealment 2011 (the public key) is held in the information holding unit 133 as described above.

Further, the information or attribute acquisition proxy apparatus 10 performs the following operation as a predetermined operation.

Enc(A)*Enc(R)

Enc(B)*Enc(R)

This operation is an operation in which the concealed information 2030 is multiplied by the concealed random number.

Here, as described above, the public key of the service providing apparatus 20 is the additive homomorphic encryption. Therefore, the result of the above-mentioned operation is shown as follows.

Enc(A)*Enc(R)=Enc(A+R)

Enc(B)*Enc(R)=Enc(B+R)

The information or attribute acquisition proxy apparatus 10 returns this operation result (Enc(A+R), Enc(B+R)) to the service providing apparatus 20 as the random number addition information 2040.

The service providing apparatus 20, which receives the random number addition information 2040 which is the operation result, decrypts the random number addition information 2040 with the own secret key. As a result, the service providing apparatus 20 acquires two values of “A+R” and “B+R”.

The service providing apparatus 20 can calculates the amount of difference (A−B) between the account balance (A) and the amount of debt (B) based on the difference between two values, that is, a result calculating “(A+R)−(B+R)=A−B”. However, because the service providing apparatus 20 does not know the random number R, the service providing apparatus 20 cannot know the value of the account balance (A) and the value of the amount of debt (B) respectively.

Thus, the information or attribute acquisition proxy apparatus 10 according to this exemplary embodiment can act as a proxy of information acquisition of the service providing apparatus 20, acquire the information held in the information or attribute providing apparatus 30 while concealing the information from the information or attribute acquisition proxy apparatus 10, and transmit it to the service providing apparatus 20 while concealing it.

Further, the configuration of the information or attribute acquisition proxy apparatus 10 according to this exemplary embodiment is not limited to the above-mentioned configuration, it may composes two or more configurations as one configuration, or realizes that each configuration is composed of a plurality of configurations.

And, the information or attribute acquisition proxy apparatus 10 is not limited to the configuration with one apparatus. This exemplary embodiment may be configured as a system in which the apparatus including one or more configurations is connected to each other via the network and which acts as a proxy of the information acquisition.

Further, the information or attribute acquisition proxy apparatus 10 may be configured as a part of another apparatus.

Next, a modification example according to the first exemplary embodiment of the present invention will be described.

### Modification Example 1

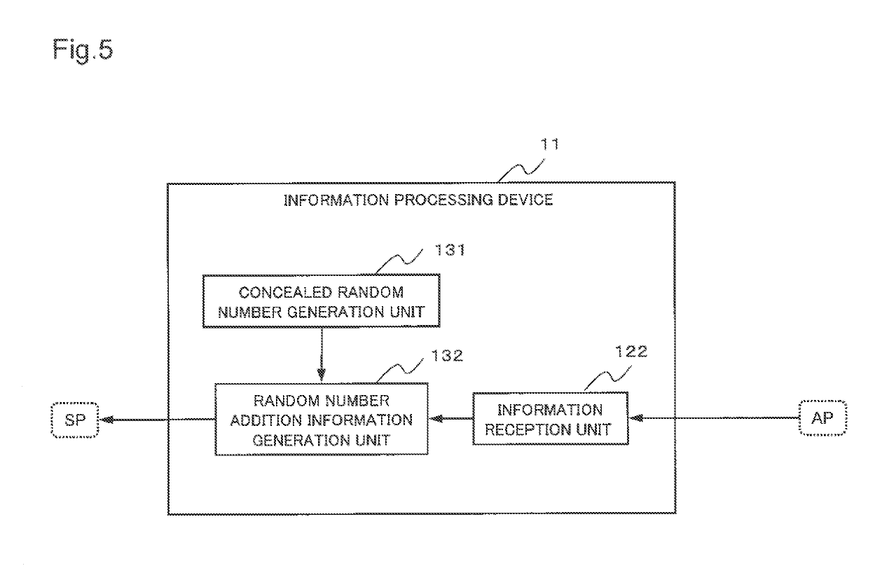

FIG. 5 is a block diagram showing an example of a configuration of an information processing device 11 having another configuration according to this exemplary embodiment. As described later, the operation of the information processing device 11 described here is similar to the operation of the information or attribute acquisition proxy apparatus 10 which has been already described.

In FIG. 5, the same reference numbers are used for the units having the same configurations as those of the units shown in FIG. 2.

The information processing device 11 shown in FIG. 5 is installed in the apparatus such as a blade server in which a plurality of apparatuses such as servers are installed. Then, the information processing device 11 is connected to the service providing apparatus (SP) 20 and the information or attribute providing apparatus (AP) 30 through an internal bus which is not shown in figure. Therefore, in FIG. 5, the configuration of transmitting and receiving the information is omitted.

And, the information request 2010 is transmitted to the information or attribute providing apparatus 30 via the internal bus by the service providing apparatus 20. The information processing device 11 performs a process after receiving the concealed information 2030 from the information or attribute providing apparatus 30.

Therefore, the information processing device 11 includes the information reception unit 122, the concealed random number generation unit 131, and the random number addition information generation unit 132.

The information reception unit 122 receives the concealed information 2030 from the information or attribute providing apparatus 30, and transmits it to the random number addition information generation unit 132.

The concealed random number generation unit 131 generates the random number, generates the concealed random number which is concealed (encrypted) with the information for concealment 2011 (the public key) of the service providing apparatus 20 which is received in advance, and transmits it to the random number addition information generation unit 132.

The random number addition information generation unit 132, which receives the concealed information 2030 and the concealed random number, generates the random number addition information 2040 as the information or attribute acquisition proxy apparatus 10, and transmits it to the service providing apparatus 20.

Thus, the information processing device 11 can generate the random number addition information 2040 based on the concealed information 2030 received from the information or attribute providing apparatus 30 while concealing it like the information or attribute acquisition proxy apparatus 10.

Further, the information processing device 11 becomes a minimum configuration of this exemplary embodiment.

### Modification Example 2

Alternatively, the information or attribute acquisition proxy apparatus 10 according to this exemplary embodiment does not need to acquire the information of the information or attribute providing apparatus 30 by only one. When using the same information for concealment 2011 (the public key) of the service providing apparatus 20 and the same concealed random number, the plurality of the information or attribute acquisition proxy apparatuses 10 can generate the random number addition information 2040 which can be processed by the service providing apparatus 20.

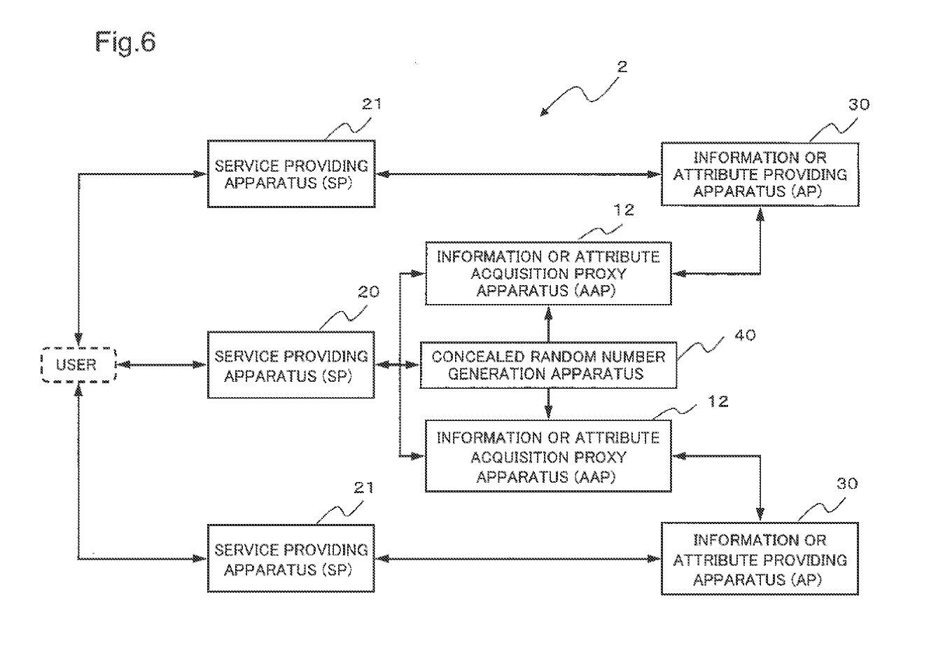

FIG. 6 is a block diagram showing an example of a service provision system 2 including a plurality of the information or attribute acquisition proxy apparatuses 12.

In FIG. 6, the same reference numbers are used for the units having the same configurations as those of the units shown in FIG. 1 and the detailed description is omitted.

The service provision system 2 shown in FIG. 6 includes the service providing apparatus 20, the service providing apparatus 21, the information providing apparatus 30, the information or attribute acquisition proxy apparatus 12, and an concealed random number generation apparatus 40.

The concealed random number generation apparatus 40 receives the information for concealment 2011 (the public key) from the service providing apparatus 20, generates the concealed random number, and transmits it to the information or attribute acquisition proxy apparatus 12.

The information or attribute acquisition proxy apparatus 12 similarly performs the operation like as the information or attribute acquisition proxy apparatus 10. However, the information or attribute acquisition proxy apparatus 12 receives the concealed random number from the concealed random number generation apparatus 40. Therefore, the each information or attribute acquisition proxy apparatus 12 generates the random number addition information 2040 by using the same concealed random number. As a result, the service providing apparatus 20 can use the random number addition information 2040 received from any one of the information or attribute acquisition proxy apparatuses 12 to the process for service while concealing it like the case in which the random number addition information 2040 is received from the information or attribute acquisition proxy apparatus 10.

Thus, the service provision system 2 can provide the service while concealing the information like the service provision system 1.

### Modification Example 3

Further, in FIG. 1, there is a case in which the service providing apparatus 20 wants to conceal the designation information 2012 from the information or attribute acquisition proxy apparatus 10.

In this case, the information or attribute acquisition proxy apparatus 10 may receive the information request 2010 including the designation information 2012 which is concealed (encrypted) with the public key of the information or attribute providing apparatus 30 from the service providing apparatus 20.

This operation will be described with reference to FIG. 1.

Because the service providing apparatus 20 knows the information or attribute providing apparatus 30 which holds the designation information 2012, the service providing apparatus 20 acquires the public key of the information or attribute providing apparatus 30 from a public key management server which is not shown, conceals (encrypts) the designation information 2012 with the public key, incorporates it in the information request 2010, and transmits it to the information or attribute acquisition proxy apparatus 10.

The information or attribute acquisition proxy apparatus 10 performs the same operation as that described above, and transmits the individual apparatus request 2020 including the concealed designation information 2012 to the information or attribute providing apparatus 30. Because the designation information 2012 is concealed with the public key of the information or attribute providing apparatus 30, the information or attribute acquisition proxy apparatus 10 cannot decrypt the designation information 2012.

The information or attribute providing apparatus 30 decrypts the concealed designation information 2012 included in the received individual apparatus request 2020 with the secret key held in itself. After this operation, the information or attribute providing apparatus 30 performs the same operation as the operation described above.

Based on such operation, the information or attribute acquisition proxy apparatus 10 according to the modification example of this exemplary embodiment can conceal (encrypt) the designation information 2012 and perform the process.

Thus, the information or attribute acquisition proxy apparatus 10 according to the first exemplary embodiment can achieve the effect in which the information can be acquired from the information or attribute providing apparatus 30 while concealing it, and the service can be provided while concealing the information in the service providing apparatus 20.

The reason will be described below.

The information or attribute acquisition proxy apparatus 10 receives the concealed information which is concealed with the homomorphic information for concealment. Therefore, the information or attribute acquisition proxy apparatus 10 cannot know the information.

Further, the information or attribute acquisition proxy apparatus 10 performs a predetermined operation based on the received concealed information and the random number while concealing them, and returns the operation result to the service providing apparatus 20 as the random number addition information. Accordingly, the service providing apparatus 20 which does not know the random number cannot know the information other than the information used for service provision.

### Second Exemplary Embodiment

Because the service providing apparatus 20 calculates the difference of the information, the information or attribute acquisition proxy apparatus 10 according to the first exemplary embodiment performs the operation to calculate the random number addition information 2040 as a product of the concealed information 2030 and the concealed random number (the inside of the function is a sum of the information and the random number before concealed). However, the process used when the service providing apparatus 20 provides the service is not limited to the difference of information. Therefore, the operation performed by the information or attribute acquisition proxy apparatus 10 is not limited to the operation according to the first exemplary embodiment.

An information or attribute acquisition proxy apparatus 13 according to a second exemplary embodiment has a plurality of operation processes and changes the operation process according to the process (utilization form) performed by the service providing apparatus 20.

First, the configuration of the information or attribute acquisition proxy apparatus 13 according to the second exemplary embodiment will be described with reference to the drawing.

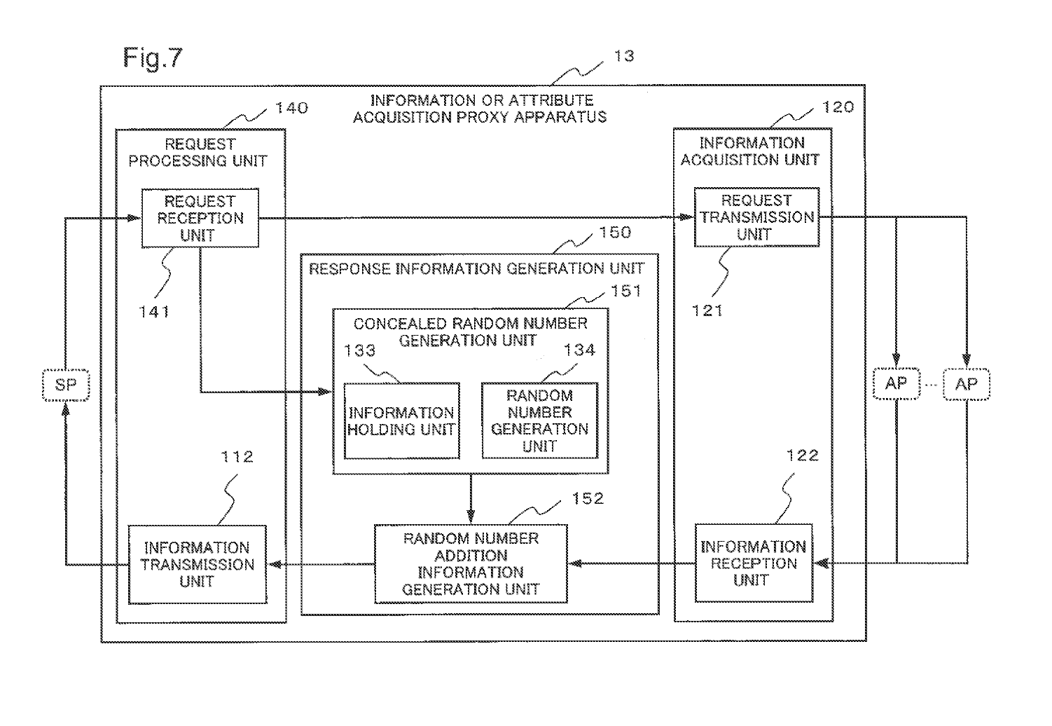

FIG. 7 is a block diagram showing an example of the configuration of the information or attribute acquisition proxy apparatus 13 according to the second exemplary embodiment. In FIG. 7, the same reference numbers are used for the units having the same configurations as those of the units shown in FIG. 2 and the detailed description is omitted.

The information or attribute acquisition proxy apparatus 13 includes a request processing unit 140, the information acquisition unit 120, and a response information generation unit 150.

The request processing unit 140 includes a request reception unit 141 and the information transmission unit 112.

The request reception unit 141 transmits the information on the process performed by the service providing apparatus 20 to the response information generation unit 150 as well as performing the operation which is similar to that performed by the request reception unit 111. Accordingly, the information request 2010 according to the second exemplary embodiment includes information (hereinafter, this information is referred to as SP process information) which indicates the process performed by the service providing apparatus 20 in addition to the information request 2010 according to the first exemplary embodiment. The request reception unit 141 extracts the SP process information from the information request 2010 in addition to the information for concealment 2011 and transmits it to the response information generation unit 150. Further, the process which is indicated by the SP process information and performed by the service providing apparatus 20 will be described later.

The information transmission unit 112 transmits the random number addition information 2040 generated by the response information generation unit 150 to the service providing apparatus 20 like the first exemplary embodiment.

Because the information acquisition unit 120 is the same as the first exemplary embodiment, the detailed description is omitted.

The response information generation unit 150 includes a concealed random number generation unit 151 and a random number addition information generation unit 152.

The concealed random number generation unit 151 generates the concealed random number like the concealed random number generation unit 131 according to the first exemplary embodiment, and transmits it to the random number addition information generation unit 152. Further, the concealed random number generation unit 151 transmits the random number generated by the random number generation unit 134 to the random number addition information generation unit 152, too.

The random number addition information generation unit 152 has a plurality of operations using the concealed information 2030 and the concealed random number or the random number, selects the operation based on the SP process information received from the request reception unit 141, and generates the random number addition information 2040.

Next, the operation of the random number addition information generation unit 152 will be further described with reference to the drawing.

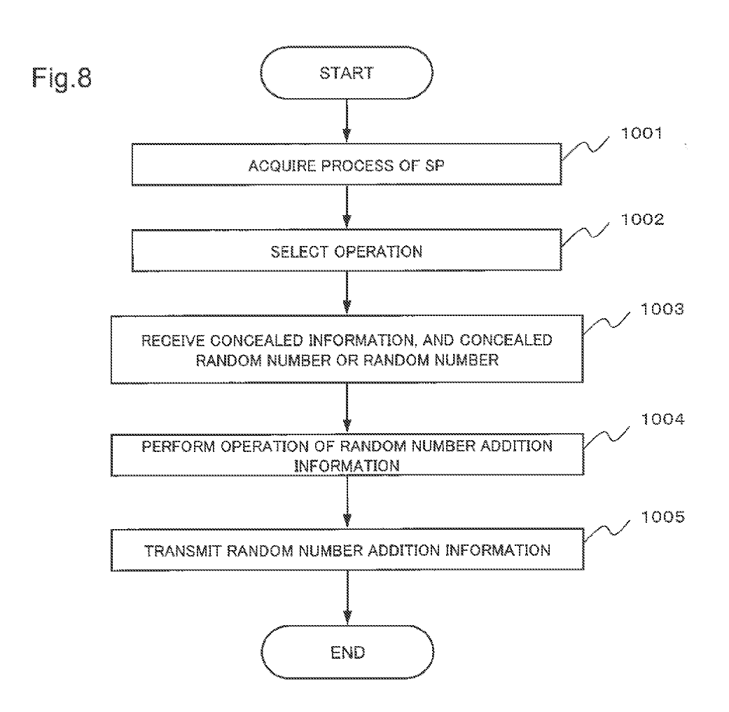

FIG. 8 is a flowchart showing an example of the operation of the random number addition information generation unit 152 according to the second exemplary embodiment.

First, the random number addition information generation unit 152 receives the information (SP process information) of the process performed by the service providing apparatus 20 from the request reception unit 141 (step 1001).

The random number addition information generation unit 152 selects the operation using the concealed information 2030 and the concealed random number or the random number based on the SP process information (step 1002). This operation will be described later.

Next, the random number addition information generation unit 152 receives the concealed information 2030 from the information reception unit 122 and receives the concealed random number or the random number from the concealed random number generation unit 131 like the random number addition information generation unit 132 according to the first exemplary embodiment (step 1003).

The random number addition information generation unit 152 performs the operation selected in step 1002 by using the received concealed information 2030 and the concealed random number or the random number, and generates the random number addition information 2040 (step 1004).

The random number addition information generation unit 152 transmits the random number addition information 2040 to the information transmission unit 112 (step 1005).

Based on such operation, the random number addition information generation unit 152 generates the random number addition information 2040 on the basis of the process performed by the service providing apparatus 20.

Next, an example of the operation performed by the random number addition information generation unit 152 according to this exemplary embodiment and an example of the process performed in the service providing apparatus 20 according to the process performed by the service providing apparatus 20 will be described.

Further, for convenience of explanation, it is supposed that the information for concealment 2011 according to this exemplary embodiment uses the public key of a multiplicative homomorphic encryption in addition to the public key of the additive homomorphic encryption used in the first exemplary embodiment. Further, the multiplicative homomorphic encryption can be supposed a variety, too. However, in the description described below, it is supposed that the multiplicative homomorphic encryption satisfies the following equation.

Multiplicative homomorphic encryption:Enc(x)*Enc(y)=Enc(x*y)

Further, for convenience of explanation, it is supposed that the information for concealment 2011 includes the public key of the additive homomorphic encryption and the public key of the multiplicative homomorphic encryption.

Further, the public key may be one public key of both the additive homomorphic encryption and the multiplicative homomorphic encryption. In this case, the information for concealment 2011 includes one public key.

Next, as an example of the process indicated by the SP process information, the cases of using the difference of information, the magnitude comparison, the coincidence judgment, and the ratio comparison will be described, respectively.

(1) Difference

When the service providing apparatus 20 calculates the difference of information, the random number addition information generation unit 152 decides that it is the difference based on the SP process information. Next, the random number addition information generation unit 152 performs the following operation by using the public key of the additive homomorphic encryption in the information request 2010 like the random number addition information generation unit 132 according to the first exemplary embodiment.

Enc(A)*Enc(R)=Enc(A+R)

Enc(B)*Enc(R)=Enc(B+R)

Here, it is supposed that “A”, “B”, and “R” are the same as those in the first exemplary embodiment. As described above, the left side of the equations of this operation is the power of the concealed information 2030 by the concealed random number.

The service providing apparatus 20 acquires “A+R” and “B+R” from the above-mentioned operation result (random number addition information 2040) by using the secret key and calculates “(A+R)−(B+R)=A−B” which is the difference.

(2) Ratio Comparison

When the service providing apparatus 20 judges the ratio (proportion) of information, the random number addition information generation unit 152 performs the following operation by using the public key of the multiplicative homomorphic encryption.

Enc(A)*Enc(R)=Enc(A*R)

Enc(B)*Enc(R)=Enc(B*R)

Here, it is supposed that “A”, “B”, and “R” are the same as those in the first exemplary embodiment like “difference” described above. Here, it is supposed that “R” is a value other than the value of the prime number. This reason will be described later.

The left sides of these equations are the powers of the concealed information 2030 by the concealed random number.

Further, the random number addition information generation unit 152 may perform the following operation by using the public key of additive homomorphic encryption.

Enc(A)̂R=Enc(A*R)

Enc(B)̂R=Enc(B*R)

Here, “̂” indicates a power. Further, the left sides of these equations are the natural number powers (R (random number) power) of “Enc (A)”.

The service providing apparatus 20 acquires “A*R” and “B*R” from the above-mentioned operation result (random number addition information 2040) by using the secret key. Further, the service providing apparatus 20 calculates the ratio shown below.

(A*R)/(B*R)=A/B

Here, the reason why “R” is not the prime number will be described.

When R is the prime number and either A or B is the prime number, the service providing apparatus 20 can calculate the values of A, B, and R based on the prime factorization of A*R or B*R.

This will be explained by using a specific value.

As an example, a case when R=2, A=7, and B=15 will be described.

In this case, A*R=14 and B*R=30 are calculated. 14 becomes 2*7 when it is factorized into prime numbers. In other words, A*R is the power of two prime numbers. Therefore, the service providing apparatus 20 reasons that R becomes 2 or 7. And, 30 cannot be divided by 7. Therefore, the service providing apparatus 20 can reason that R is 2 based on B*R=30. As a result, the service providing apparatus 20 can determine the each values as “A=7, B=15, and R=2”.

On the other hand, a case in which R is not the value of the prime number will be described.

As an example, a case when R=6, A=7, and B=5 will be described.

In this case, A*R=42 and B*R=30 are calculated.

When each value is factorized into prime numbers, the results is calculates as follows.

42=2*3*7

30=2*3*5

In this case, the service providing apparatus 20 can reasons that the value of R is one of 2, 3, and 6, but cannot decide one of them. As a result, the service providing apparatus 20 cannot determine the values of A and B.

Thus, the service providing apparatus 20 can know the ratio of information. However, because the service providing apparatus 20 does not know the random number R, the service providing apparatus 20 cannot know the values of A and B.

(3) Magnitude Comparison

When the service providing apparatus 20 judges the magnitude of information, the random number addition information generation unit 152 may perform the operation which is the same as the operation for the difference or the ratio comparison. However, when it is required that the value of the difference and the ratio are concealed from the service providing apparatus 20, the random number addition information generation unit 152 performs the following operation by using the public key of the addition homomorphic encryption.

(Enc(A)̂R1)*Enc(R2)=Enc(A*R1+R2)

(Enc(B)̂R1)*Enc(R2)=Enc(B*R1+R2)

Here, “̂” indicates a power. And, R1 and R2 are the random numbers generated by the random number generation unit 134. However, it is supposed that R1 is not the prime number like the ratio comparison. Further, R1 and R2 are the natural numbers. Therefore, “Enc(A)̂ R1” is the natural number power (R 1(random number) power) of “Enc(A)”.

The service providing apparatus 20 acquires “A*R1+R2” and “B*R1+R2” from the above-mentioned operation result (random number addition information 2040) by using the secret key. Further, the service providing apparatus 20 calculates the random number (natural number) times of the difference (A−B) by using the following equation.

(A*R1+R2)−(B*R1+R2)=(A−B)*R1

The service providing apparatus 20 can determine a magnitude relationship between A and B based on a sign of the random number R1 (natural number) times of the difference calculated by the above-mentioned equation. However, because the service providing apparatus 20 does not know the random number R1, it cannot know the value of (A−B) which is the difference. Further, because the service providing apparatus 20 does not know the value of R2 too, it cannot acquire (A/B), that is, the ratio.

Further, the random number addition information generation unit 152 may perform the following operation by using the public key of the additive homomorphic encryption.

(Enc(A)̂R1)*(Enc(B)̂R2)=Enc(A*R1+B*R2)

(Enc(B)̂R1)*(Enc(A)̂R2)=Enc(B*R1+A*R2)

However, it is supposed that R1 and R2 are the random numbers generated by the random number generation unit 134 and satisfy R1>R2. And, it is supposed that (R1−R2) is not the prime number.

The service providing apparatus 20 acquires “A*R1+B*R2” and “B*R1+A*R2” from the above-mentioned operation result (random number addition information 2040) by using the secret key. Further, the service providing apparatus 20 calculates a multiple of the difference (A−B) by using the following equation.

(A*R1+B*R2)−(B*R1+A*R2)=(A−B)*(R1−R2)

Because of R1>R2, in other words, (R1−R2)>0, the service providing apparatus 20 can determine the magnitude relationship between A and B based on the sign of the multiple of the difference calculated by the above-mentioned equation. However, because the service providing apparatus 20 does not know the random numbers R1 and R2, it cannot know the value of (R1−R2). Therefore, the service providing apparatus 20 cannot know the value of (A−B) which is the difference. Further, because the service providing apparatus 20 does not know the values of R1 and R2 too, it cannot calculates (A/B), that is, the ratio.

(4) Coincidence Judgment

When the service providing apparatus 20 judges the coincidence of information, the random number addition information generation unit 152 may perform the operation which is the same as the operation for the difference judgment, the ratio comparison, or the magnitude comparison. However, when it is required that the difference, the ratio, and the magnitude are concealed from the service providing apparatus 20, the random number addition information generation unit 152 performs the following operation by using the public key of the additive homomorphic encryption.

(Enc(A)̂R1)*(Enc(B)̂R2)=Enc(A*R1+B*R2)

(Enc(A)̂R3)*(Enc(B)̂R4)=Enc(A*R3+B*R4)

However, the random number R1 to the random number R4 are the random numbers generated by the random number generation unit 134 and satisfy the following conditions.

R1≠R3 a)

R1+R2=R3+R4,this is,R4=R1+R2−R3 b)

Here, the left sides of the equation become multiplications which are the different natural number powers (random number powers) of the concealed information 2030.

The service providing apparatus 20 acquires “A*R1+B*R2” and “A*R3+B*R4” by using the secret key. Further, the service providing apparatus 20 calculates the difference shown below.

(A*R1+B*R2)−(A*R3+B*R4)

When A is equal to B, this difference is 0. In other words, the service providing apparatus 20 can know whether or not the values are equal to each other based on whether or not the difference is 0. However, because the service providing apparatus 20 does not know the random number R1 to the random number R4, it cannot know the values of A and B, the difference of the values, the ratio, and the magnitude.

Here, it will be described that when A is equal to B, the difference is 0.

When R1+R2−R3 is substituted for R4 in the equation of the difference and the equation is arranged, the equation is as following.

(A−B)*(R1−R3)

Here, because of R1≠R3, when the difference is 0, A−B is equal to 0 (A−B=0), in other words, A is equal to B (A=B).

Thus, the information or attribute acquisition proxy apparatus 13 according to the second exemplary embodiment can achieve the effect corresponding to the different process in the service providing apparatus 20 in addition to the effect according to the first exemplary embodiment.

This is because the information or attribute acquisition proxy apparatus 13 according to the second exemplary embodiment receives the SP process information indicating the process performed by the service providing apparatus 20, and changes the operation used in the response information generation unit 130 based on the SP process information.

### Third Exemplary Embodiment

The information or attribute acquisition proxy apparatus 13 according to the second exemplary embodiment changes the operation based on the process (SP process information) performed by the service providing apparatus 20. However, the change in the operation of the information or attribute acquisition proxy apparatus 13 is not limited to the SP process information.

The information or attribute acquisition proxy apparatus 13 according to the third exemplary embodiment changes the operation based on other information in addition to the SP process information.

Because the configuration of the information or attribute acquisition proxy apparatus 13 according to the third exemplary embodiment is the same as that of the information or attribute acquisition proxy apparatus 13 according to the second exemplary embodiment shown in FIG. 7, the detailed description is omitted and the operation peculiar to the information or attribute acquisition proxy apparatus 13 according to the third exemplary embodiment will be described.

The random number addition information generation unit 152 according to the third exemplary embodiment receives other information from the request reception unit 141 in addition to the SP process information.

Here, the other information received by the random number addition information generation unit 152 according to the third exemplary embodiment is not limited in particularly. In the following description, as an example, a case in which the designation information 2012, in particular the attribute type 2015, is used will be described.

Such case will be described with reference to the drawing.

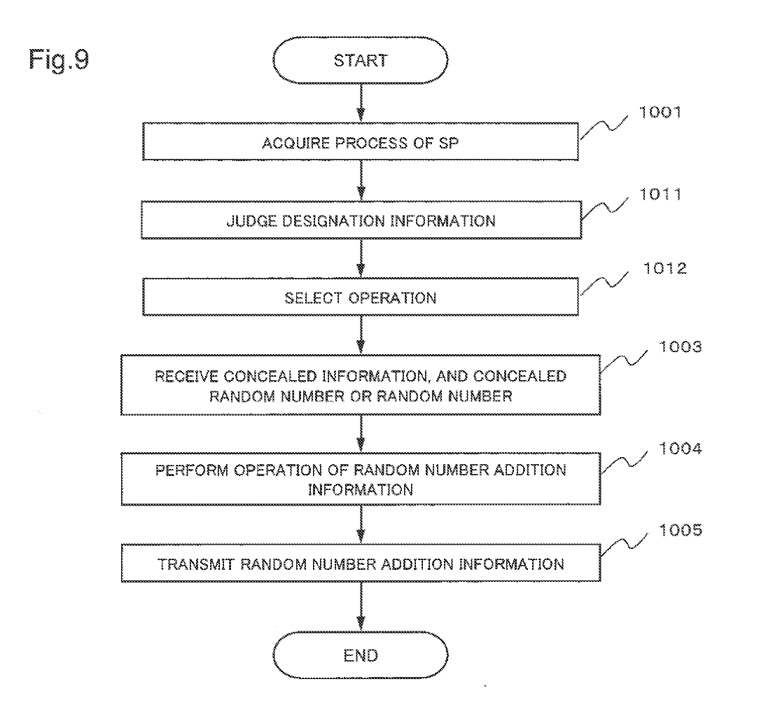

FIG. 9 is a flowchart showing an example of the operation of the random number addition information generation unit 152 according to the third exemplary embodiment. In FIG. 9, the same reference numbers are used for the same operations as those shown in FIG. 8.

First, the random number addition information generation unit 152 receives the information (SP process information) of the process performed by the service providing apparatus 20 from the request reception unit 141 (step 1001).

Next, the random number addition information generation unit 152 judges the designation information 2012 (in this case, the attribute type 2015) (step 1011).

The random number addition information generation unit 152 selects the operation of the concealed information 2030 and the concealed random number or the random number based on the SP process information and the designation information 2012 (step 1012). As this selection, the random number addition information generation unit 152 selects the highly concealed operation even if the processing load is high when the designation information 2012 is the information which is highly concealed, and selects the lower load operation when the designation information 2012 is the information which is not required to be relatively highly concealed.

Further, this operation of step 1012 will be described by using a specific example.

First, for convenience of explanation, the precondition will be arranged.

It is supposed that the concealed information 2030 is the public key of the additive homomorphic encryption.

It is supposed that the processed information and the process are a comparison between a certain user's deposit (D) and a price (P) of the goods which the user wants to buy and a comparison between the permitted number of holidays (H) and the number of used holidays (A), in other words, the SP process information is the magnitude comparison. Further, it is supposed that the deposit has higher concealment than the number of holidays.

Next, the operation will be described.

First, the random number addition information generation unit 152 confirms the SP process information and judges that the process is the magnitude comparison. Next, the random number addition information generation unit 152 confirms the designation information 2012, in other words, the attribute type 2015 of the processed information.

Here, when the processed attribute type 2015 is the deposit, the random number addition information generation unit 152 performs the following operation like the magnitude comparison performed in the second exemplary embodiment.

(Enc(D)̂R)=Enc(D*R)

(Enc(P)̂R)=Enc(P*R)

The service providing apparatus 20 which receives the result of this operation (random number addition information 2040) can perform the magnitude comparison between the deposit (D) and the price (P). However, the service providing apparatus 20 cannot calculate the difference (D−P) between the deposit (D) and the price (P).

On the other hand, when the processed attribute type 2015 is the number of holidays, the random number addition information generation unit 152 performs the following operation based on the permitted number of holidays (H) and the number of used holidays (A).

Enc(H)*Enc(R)=Enc(H+R)

Enc(A)*Enc(R)=Enc(A+R)

The service providing apparatus 20 can perform the magnitude comparison of the numbers of the holidays by using this operation result (random number addition information 2040). Further, the service providing apparatus 20 can calculate the difference (D−A) between the number of the permitted days (H) and the number of used days (A). However, the service providing apparatus 20 cannot calculate the number of the permitted days (D) and the number of used days (A). Thus, because the difference can be calculated, the concealment in the case of the number of holidays is lower than that in the case of the deposit. However, the operation in the case of the number of holidays is one multiplication, that is smaller multiplication number of times in comparison with the number in operation used for the deposit. Accordingly, the operation load of the random number addition information generation unit 152 is lower.

Thus, the random number addition information generation unit 152 can use the highly concealed operation to the attribute type 2015 which is highly concealed even if the operation load is higher, and use the operation whose operation load is lower to the attribute type 2015 which is not required to be highly concealed.

Further, the random number addition information generation unit 152 does not change the type of the operation but may change a size (the number of bits, the number of bytes, or the like) of the random number used for the operation. When the random number is large, the calculation amount is large but the concealment is high. On the other hand, when the random number is small, the concealment is low but the calculation amount is small. Therefore, the random number addition information generation unit 152 may use the large random number to the information to be highly concealed and use the small random number to the information that is not required to be highly concealed.

The explanation of the flowchart shown in FIG. 9 will be returned.

The random number addition information generation unit 152 receives the concealed information 2030 from the information reception unit 122 and the concealed random number or the random number from the concealed random number generation unit 131 like the random number addition information generation unit 132 according to the second exemplary embodiment (step 1003).

The random number addition information generation unit 152 performs the operation selected in step 1012 by using the received concealed information 2030 and the concealed random number or the random number, and generates the random number addition information 2040 (step 1004).

The random number addition information generation unit 152 transmits the random number addition information 2040 to the information transmission unit 112 (step 1005).

Based on such operation, the random number addition information generation unit 152 according to the third exemplary embodiment selects the operation based on the SP process information of the service providing apparatus 20 and the designation information 2012, and generates the random number addition information 2040 which is an operation result.

Further, though the random number addition information generation unit 152 according to the third exemplary embodiment described above selects the operation based on the designation information 2012, in particular the attribute type 2015, it is not limited to this. For example, the random number addition information generation unit 152 may receive the information (for example, the user ID 2014) of the user to which the service providing apparatus 20 provides the service, and change the operation based on the user's information.

When this is described more specifically, for example, it is described as follows.

When the service providing apparatus 20 provides the service by using information on a plurality of users, the highly concealed process is necessary because the extent of the influence of the leakage is wide. In contrast, when the service providing apparatus 20 provides the service by using information on each user, there is a case in which it is desirable that the process is performed quickly and shorten the response time without performing the highly concealed process in comparison with a case of a plurality of users because the extent of the influence of the leakage is narrow.

Therefore, the random number addition information generation unit 152 decides the range of the user by using the user information (for example, the user ID 2014) with respect to the process performed by the service providing apparatus 20, and selects either the highly concealed operation whose processing load is high or the not highly concealed operation whose processing load is low.

Thus, the information or attribute acquisition proxy apparatus 13 according to the third exemplary embodiment can achieve the effect in which the processing load can be reduced in addition to the effect according to the second exemplary embodiment.

This is because the random number addition information generation unit 152 according to the third exemplary embodiment decides a concealment based on the attribute type of the required information or the user's information, selects the operation whose processing load is low when the not highly concealed operation whose processing load is low can be used, and performs it.

### Fourth Exemplary Embodiment

As for the information or attribute acquisition proxy apparatus 13 according to the second exemplary embodiment, the acquired information is explained as two. However, for the information or attribute acquisition proxy apparatus 13, the acquired information is not limited to two.

As a fourth exemplary embodiment, the information or attribute acquisition proxy apparatus 13 which acquires three or more information will be described.

Further, because the configuration of the information or attribute acquisition proxy apparatus 13 according to the fourth exemplary embodiment is the same as that of the information or attribute acquisition proxy apparatus 13 according to the second exemplary embodiment shown in FIG. 7, the detailed explanation of the configuration is omitted and the operation peculiar to the information or attribute acquisition proxy apparatus 13 according to the fourth exemplary embodiment will be described.

The random number addition information generation unit 152 according to the fourth exemplary embodiment receives information (hereinafter, this information is referred to as combination information) about which information and how to be integrated (combined) it in addition to the process performed by the service providing apparatus 20 as the SP process information.

Here, the combination information is a combination of information on the process performed by the service providing apparatus 20. For example, when the credit information is generated based on the deposit (A) and two debts (B and C), the service providing apparatus 20 compares “A” with “B+C”. The combination information in this case is the combination of “A” and “B+C”.

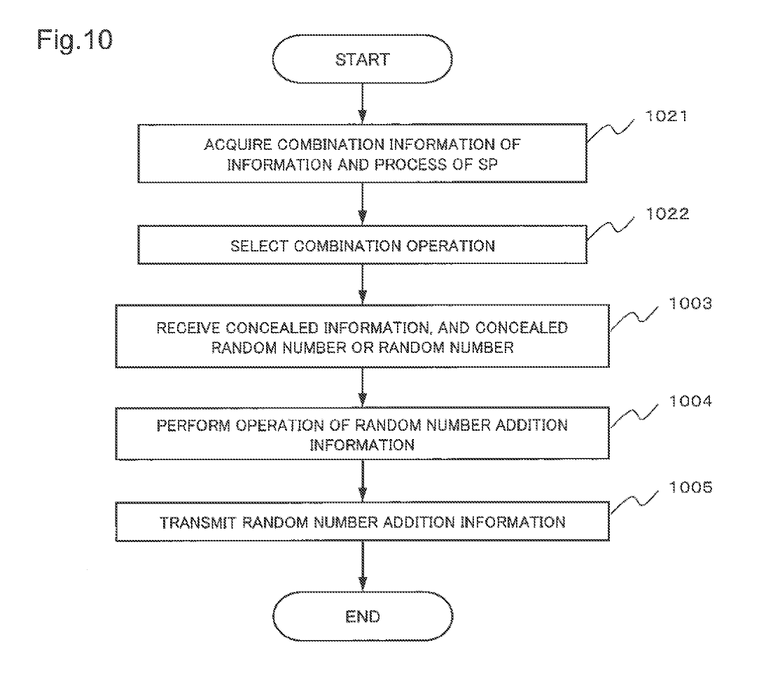

FIG. 10 is a flowchart showing an example of the operation of the random number addition information generation unit 152 according to such the fourth exemplary embodiment. In FIG. 10, the same reference numbers are used for the same operations as those shown in FIG. 8.

First, the random number addition information generation unit 152 receives the information (SP process information) on the process performed by the service providing apparatus 20 and the combination information from the request reception unit 141 (step 1021).

Next, the random number addition information generation unit 152 selects the operation based on the SP process information and the combination information (step 1022).

Further, this operation of step 1022 will be described by using a specific example.

Here, as an example, the explanation will be performed by using the deposit (A) and two debts (B and C) which have already been described.

The random number addition information generation unit 152 selects the operation to calculate the random number addition information 2040 transmitted to the service providing apparatus 20 based on the SP process information (in this case, the difference) and the combination information (in this case, A and B+C). In this case, it is the following operation.

Enc(A)*Enc(R)=Enc(A+R)

Enc(B)*Enc(C)*Enc(R)=Enc(B+C+R)

The left side of the second equation is a multiplication the plurality of the concealed information 2030 by the concealed arithmetic.

The service providing apparatus 20 decrypts the received random number addition information 2040 with the secret key, calculates “(A+R)−(B+C+R)”, and can calculate the difference (“A−(B+C)”) between the deposit and the debt. However, because the service providing apparatus 20 does not know the random number R, the service providing apparatus 20 cannot know the values of A, B, and C.

In the process after this process, the random number addition information generation unit 152 operates like the random number addition information generation unit 132 according to the second exemplary embodiment.

In other words, the random number addition information generation unit 152 receives the concealed information 2030 (Enc(A), Enc(B), and Enc(C)) from the information reception unit 122 and the concealed random number or the random number from the concealed random number generation unit 131 (step 1003).

The random number addition information generation unit 152 performs the operation selected in step 1022 by using the concealed information 2030 and the concealed random number or the random number which are received, and generates the random number addition information 2040 (in this case, Enc(A+R) and Enc(B+C+R)) (step 1004).

The random number addition information generation unit 152 transmits the random number addition information 2040 to the information transmission unit 112 (step 1005).

Based on such operation, the random number addition information generation unit 152 according to the fourth exemplary embodiment generates the random number addition information 2040 which is the operation result based on the process performed by the service providing apparatus 20.

Further, though the random number addition information generation unit 152 according to the fourth exemplary embodiment described above selects the operation based on the combination information, it is not limited to this. For example, the random number addition information generation unit 152 may receive the attribute type 2015 (for example, the deposit and the debt) of the concealed information 2030 to be acquired, and select the operation of the concealed information 2030 based on the attribute type 2015.

The information or attribute acquisition proxy apparatus 13 according to the fourth exemplary embodiment can achieve the effect in which three or more information can be used in addition to the effect according to the second exemplary embodiment.

This is because the random number addition information generation unit 152 according to the fourth exemplary embodiment can generate the random number addition information 2040 from the acquired concealed information 2030 based on the combination information or the attribute information acquired from the service providing apparatus 20.

### Fifth Exemplary Embodiment

Each configuration of the information or attribute acquisition proxy apparatuses according to the first to fourth exemplary embodiments may be realized as a program executed by a computer.

Further, each configuration of the information or attribute acquisition proxy apparatuses according to the first to fourth exemplary embodiments may include a recording medium which stores a program executed by a computer.

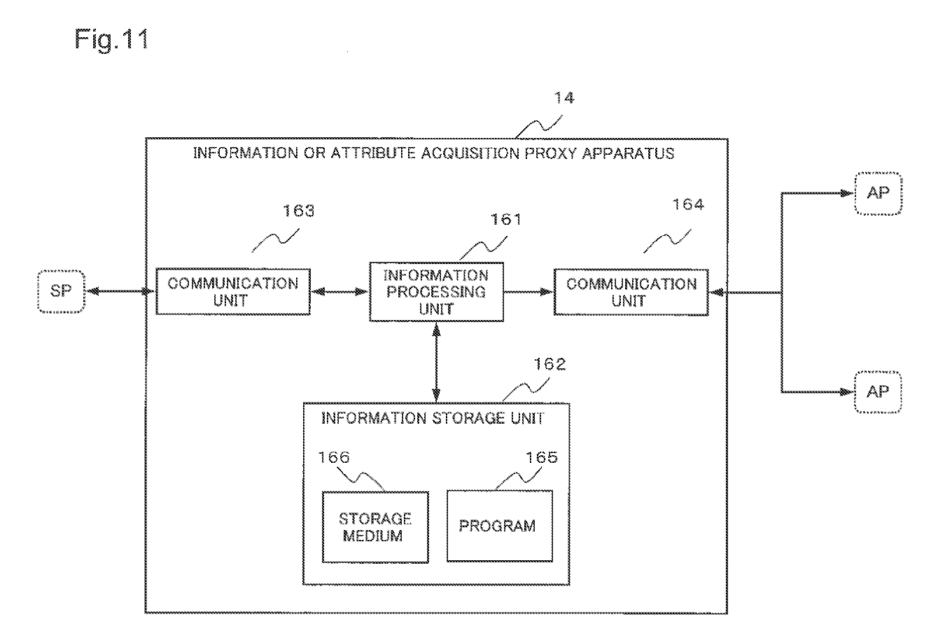

FIG. 11 is a figure showing an example of the configuration of an information or attribute acquisition proxy apparatus 14 according to a fifth exemplary embodiment.

The information or attribute acquisition proxy apparatus 14 includes an information processing unit 161, an information storage unit 162, a first communication unit 163, and a second communication unit 164.

The information processing unit 161 includes a CPU (Central Process Unit) and executes a program 165 which is the process of the information or attribute acquisition proxy and is stored by the information storage unit 162. Then, the information processing unit 161 communicates with the service providing apparatus (SP) 20 via the first communication unit 163, communicates with the information or attribute providing apparatus (AP) 30 via the second communication unit 164, and performs the same operation as the information or attribute acquisition proxy apparatuses according to the first to fourth exemplary embodiments based on the program 165.

The information storage unit 162 includes a storage apparatus such as a hard disk apparatus, a memory storage apparatus, or the like, and stores the program 165 executed by the information processing unit 161. Further, the information storage unit 162 may include a storage medium 166 which holds the program 165. Further, the information storage unit 162 may operate as a temporary save storage (work area) of the information when the information processing unit 161 executes.

The first communication unit 163 includes a circuit for connecting with the service providing apparatus (SP) 20, for example a NIC (Network interface Card), and relays the information between the information processing unit 161 and the service providing apparatus 20.

Similarly, the second communication unit 164 includes a circuit for connecting with the information or attribute providing apparatus (AP) 30, and relays the information between the information processing unit 161 and the information or attribute providing apparatus 30.

Thus, the information or attribute acquisition proxy apparatus 14 according to the fifth exemplary embodiment can achieve the same effect as the information or attribute acquisition proxy apparatuses according to the first to fourth exemplary embodiments.

This is because the information processing unit 161 of the information or attribute acquisition proxy apparatus 14 according to the fifth exemplary embodiment can perform the same operation as the information or attribute acquisition proxy apparatuses according to the first to fourth exemplary embodiments based on the program 165.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2010-254971, filed on Nov. 15, 2010, the disclosure of which is incorporated herein in its entirety by reference.

### DESCRIPTION OF SYMBOL

1 service provision system
2 service provision system
9 service provision system
10 information or attribute acquisition proxy apparatus
11 information processing device
12 information or attribute acquisition proxy apparatus
13 information or attribute acquisition proxy apparatus
14 information or attribute acquisition proxy apparatus
20 service providing apparatus
21 service providing apparatus
30 information or attribute providing apparatus
40 concealed random number generation apparatus
90 service providing apparatus
91 information or attribute providing apparatus
92 service providing apparatus
93 information or attribute providing apparatus
94 service providing apparatus
110 request processing unit
111 request reception unit
112 information transmission unit
120 information acquisition unit
121 request transmission unit
122 information reception unit
130 response information generation unit
131 concealed random number generation unit
132 random number addition information generation unit
133 information holding unit
134 random number generation unit
140 request processing unit
141 request reception unit
150 response information generation unit
151 concealed random number generation unit
152 random number addition information generation unit
161 information processing unit
162 information storage unit
163 communication unit
164 communication unit
165 program
166 storage medium
2010 information request
2011 information for concealment
2012 designation information
2013 acquisition destination information
2014 user ID
2015 attribute type
2020 individual apparatus request
2030 concealed information
2040 random number addition information

1. An information processing device comprising:
an information reception unit which receives concealed information which is concealed with information for concealment;
a concealed random number generation unit which generates a random number or a concealed random number which is concealed the random number with the information for concealment; and
a random number addition information generation unit which generates random number addition information based on the concealed information and the random number or the concealed random number.

2. The information processing device according to claim 1, wherein
the concealed information is a public key of homomorphic encryption.

3. The information processing device according to claim 2, wherein
the information for concealment is an additive homomorphic encryption, and
said random number addition information generation unit performs an operation which operates either an multiplication with the concealed information and the concealed random number, a natural number power of the concealed information, or a multiplication of two or more the concealed information which is performed different natural number power.

4. The information processing device according to claim 2, wherein
the information for concealment is a multiplicative homomorphic encryption, and
said random number addition information generation unit performs an operation which operates a multiplication with the concealed information and the concealed random number.

5. The information processing device according to claim 1, further comprising:
an information holding unit which holds the information for concealment; and
a random number generation unit which generates the random number, wherein
said concealed random number generation unit conceals the random number generated by said random number generation unit by using said information for concealment held by said information holding unit.

6. The information processing device according to claim 1, comprising:
a request reception unit which receives designation information about an acquisition information, the information for concealment which conceals the acquisition information, and acquisition destination information about an acquisition destination; and
a request transmission unit which transmits the designation information and the information for concealment to the acquisition destination indicated in the acquisition destination information.

7. The information processing device according to claim 6, wherein
said random number addition information generation unit changes the concealed random number generated by said concealed random number generation unit based on the designation information.

8. The information processing device according to claim 1, further comprising:
an information transmission unit which transmits the random number addition information to a device which transmits the information for concealment.

9. The information processing device according to claim 6, wherein
said request reception unit receives information about a utilization form of the random number addition information, and
said random number addition information generation unit changes the operation based on the information about said utilization form.

10. The information processing device according to claim 6, wherein
the designation information is encrypted with the public key of the acquisition destination.

11. The information processing device according to claim 6, wherein
said request reception unit receives information related a combination of the concealed information used for the operation by said random number addition information generation unit or an attribute type, and
said random number addition information generation unit selects the operation based on the combination information or the attribute type.

12. An information processing method comprising:
receiving concealed information which is concealed with information for concealment;
generating a random number or a concealed random number which is concealed the random number with the information for concealment; and
generating random number addition information based on the concealed information and the random number or the concealed random number.

13. A computer readable medium embodying a program, said program causing an information processing device to perform processing, said processing comprising:
receiving concealed information which is concealed with information for concealment;
generating a random number or a concealed random number which is concealed the random number with the information for concealment; and
generating random number addition information based on the concealed information and the random number or the concealed random number.

14. An information processing system comprising:
a service providing apparatus which provides service to a user;
an information or attribute providing apparatus which holds information for service provision by said service providing apparatus; and
an information processing device which receives concealed information, which is first information, concealed based on information for concealment of said service providing apparatus from said information or attribute providing apparatus, generates a random number or a concealed random number which is concealed the random number with the information for concealment, generates random number addition information, which is second information, based on the concealed information and the random number or the concealed random number, and transmits the random number addition information to said service providing apparatus.

15. An information processing device comprising:
an information reception means for receiving concealed information which is concealed with information for concealment;
a concealed random number generation means for generating a random number or a concealed random number which is concealed the random number with the information for concealment; and
a random number addition information generation means for generating random number addition information based on the concealed information and the random number or the concealed random number.
